(19) United States
(12) Patent Application Publication
(10) Pub. No.: US 2018/0310255 A1
(43) Pub. Date: Oct. 25, 2018

(54) Combining Signals In A Radio Unit

(71) Applicant: Telefonaktiebolaget LM Ericsson (publ), Stockholm (SE)

(72) Inventors: Arne Simonsson, Gammelstad (SE); Peter De Bruin, Gammelstad (SE); Bo Hagerman, Tyresö (SE)

(21) Appl. No.: 15/766,030

(22) PCT Filed: Oct. 16, 2015
(86) PCT No.: PCT/EP2015/074031

§ 371 Date: Apr. 5, 2018

(51) Int. Cl. H04W 52/24; H04B 17/318; H04W 88/08

(52) U.S. Cl. CPC H04W 52/247; H04B 17/318; H04W 52/243; H04W 88/085; H04W 52/245

(57) ABSTRACT

There is provided mechanisms for combining signals from remote radio heads in a radio unit. The method is performed by the radio unit. The method comprises obtaining signals and signal strength measurements thereof from at least two remote radio heads. The method comprises combining the obtained signals into one composite signal, wherein the signals having the signal strength measurements above a predefined level are muted.

### TECHNICAL FIELD

Embodiments presented herein relate to a method, a radio unit, a computer program, and a computer program product for combining signals from remote radio heads in the radio unit.

### BACKGROUND

In communications networks, there may be a challenge to obtain good performance and capacity for a given communications protocol, its parameters and the physical environment in which the communications network is deployed.

For example, one parameter in providing good performance and capacity for a given communications protocol in a communications network is the ability to provide network coverage at certain locations. Examples of such certain locations include, but are not limited to, indoor locations, such as indoor building locations (residential buildings, office buildings, commercial buildings, transport hubs and stations), sport stadiums, trains, ships, tunnels, etc. To enable such network coverage at certain locations a local dedicated network (such as an indoor network) is typically installed, under the assumption that an existing macro network (such as an outdoor network) cannot provide good enough network coverage at the certain locations under consideration. Such local dedicated networks are also installed to provide increased capacity.

The local dedicated network could be provided as a distributed antenna system (DAS), an active DAS, or a radio dot system (RDS). The local dedicated network is often distributed and comprises a plurality of remote radio heads (or antennas) with low individual transmit power. Thus, to achieve a desired level of network coverage at the certain locations under consideration it may be necessary to employ multiple remote radio heads. For example, in an indoor environment one remote radio head may be provided every 25 meters (or one per 625 m²) per floor. One reason for the relatively high number of remote radio heads per meter in an indoor environment is the propagation losses due to walls and floors, as well as other indoor obstacles. Another reason is that a typical indoor installation aims to achieve higher signal strength levels in comparison to the signal strength levels of the existing macro network at every position of the certain locations under consideration.

When a wireless device is served by a macro network but located at a location aimed to be served by a local dedicated network the wireless device may be transmitting at high output power very close to a remote radio head of the local dedicated network. This remote radio head can then, in turn, be severely interfered (by means of adjacent or co-channel interference). This is often referred to as a “near-far” issue. In the case of a distributed local dedicated network, the high interference at one remote radio head may block the whole local dedicated network, irrespective if the interference is at the same channel or at an adjacent channel, simply due to the high received power that risk saturating the receiving radio unit of the local dedicated network.

Power setting to balance uplink (transmission from served wireless device to network) and downlink (transmission from network to served wireless device) is commonly used, for communications networks employed in indoor as well as outdoor environments. However, individual setting of output power for remote radio heads may not be currently supported.

Further, when the gain control in the remote radio head attenuates a received signal the wanted signals (i.e., signals from wireless devices served by the local dedicated network) cannot be distinguished from external interference (i.e., signals not from wireless devices served by the local dedicated network). Attenuating received signals will reduce the external interference, but a weak wanted signal can be excluded due to attenuated below the noise floor.

Still further, since the receiving radio unit commonly is a central node in the local dedicated network and the combining of the different signal contributions from all the remote radio heads in the local dedicated network commonly is performed as an addition, one saturated remote radio head thus risks saturating the whole local dedicated network.

Hence, there is a need for an improved handling of signals in a local dedicated network.

### SUMMARY

An object of embodiments herein is to provide efficient handling of signals in a local dedicated network.

According to a first aspect there is presented a method for combining signals from remote radio heads in a radio unit. The method is performed by the radio unit. The method comprises obtaining signals and signal strength measurements thereof from at least two remote radio heads. The method comprises combining the obtained signals into one composite signal, wherein the signals having the signal strength measurements above a predefined level are muted.

Advantageously this provides efficient muting of external interference (i.e., of signals not from wireless devices served by any of the at least two remote radio heads).

Advantageously, the impact of uplink interference, due to wireless devices served by a macro network transmitting at high power could be mitigated by muting signals received from a single remote radio head.

Advantageously, this enables a local dedicated network comprising a radio unit and at least two remote radio heads to co-exist in environments populated by existing macro networks.

Advantageously, saturating and blocking all remote radio heads is thereby avoided, and, instead, only signals from those remote radio heads affected by interference are muted.

According to a second aspect there is presented a radio unit for combining signals from remote radio heads. The radio unit comprises processing circuitry. The processing circuitry is configured to cause the radio unit to obtain signals and signal strength measurements thereof from at least two remote radio heads. The processing circuitry is configured to cause the radio unit to combine the obtained signals into one composite signal, wherein the signals having the signal strength measurements above a predefined level are muted.

According to an embodiment the radio unit further comprises a storage medium storing a set of operations, and the processing circuitry is configured to retrieve the set of operations from the storage medium to cause the radio unit to perform the set of operations.

According to a third aspect there is presented a computer program for combining signals from remote radio heads in a radio unit, the computer program comprising computer program code which, when run on the radio unit, causes the radio unit to perform a method according to the first aspect.

According to a fourth aspect there is presented a computer program product comprising a computer program according to the third aspect and a computer readable medium on which the computer program is stored. The computer readable medium may be a non-transitory computer readable medium.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2a is a schematic diagram showing functional units of a radio unit according to an embodiment;

FIG. 2b is a schematic diagram showing functional modules of a radio unit name according to an embodiment;

FIG. 3 shows one example of a computer program product comprising computer readable means according to an embodiment;

FIGS. 4 and 5 are flowcharts of methods according to embodiments; and

FIG. 6 schematically illustrates a radio unit and remote radio heads according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

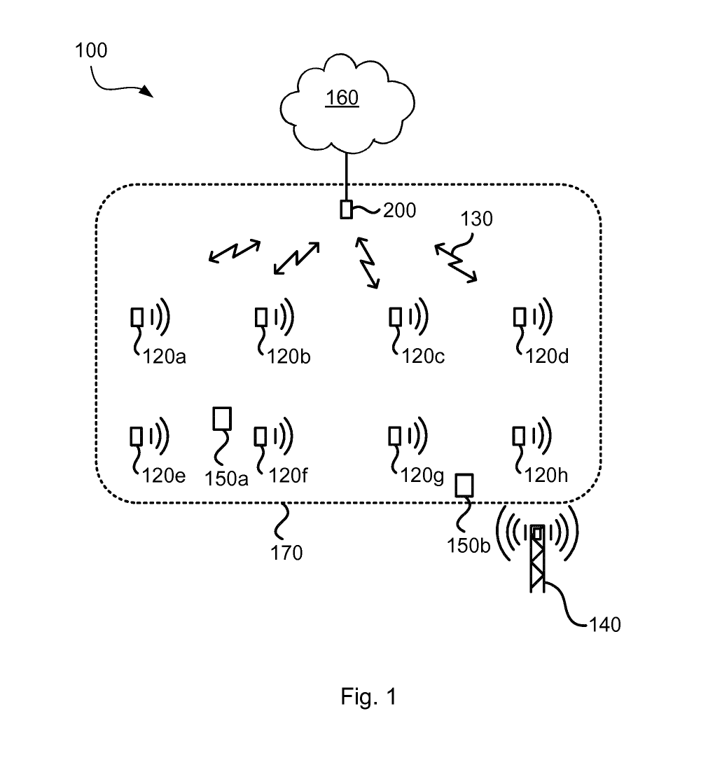

FIG. 1 is a schematic diagram illustrating a communications network 100 where embodiments presented herein can be applied. The communications network 100 comprises at least one radio unit 200. The radio unit 200 can be a radio receiver combiner, a remote radio head-end, active DAS head-end, DAS master unit, a radio control unit, or an indoor radio unit.

The at least one radio unit 200 is operatively connected to a core network 160 which in turn can be operatively connected to a service providing packet data network.

The communications network 100 further comprises at least two remote radio heads 120a, 120b, . . . , 120h, but may generally comprise a plurality of remote radio heads 120a, 120b, . . . , 120h. Each such remote radio head 120a, 120b, . . . , 120h may be a remote radio unit and be part of a Radio Dot System device. The at least two remote radio heads 120a, 120b, . . . , 120h are operatively connected to the radio unit 200. In this respect each remote radio head 120a, 120b, . . . , 120h can be defined as a spatially separated transceiver and be connected to the radio unit 200 via a corresponding port.

The remote radio heads 120a, 120b, . . . , 120h and the radio unit 200 define a radio access network 170. This radio access network 170 can be regarded as a local dedicated network.

The communications network 100 may further comprise at least one radio access network node 140. The radio access network node 140 can be a radio base station, a base transceiver station, a node B, an evolved node B, or a non-cellular access point. This at least one radio access network node 140 can be regarded as being part of another network, such as a macro network.

The at least two remote radio heads 120a, 120b, . . . , 120h and the at least one radio access network node 140 are configured to provide network access to wireless device 150a 150b. Each wireless device 150a, 150b may be a portable wireless device, a mobile station, a mobile phone, a handset, a wireless local loop phone, a user equipment (UE), a smartphone, a laptop computer, a tablet computer, a wireless modem, or a sensor.

The at least two remote radio heads 120a, 120b, . . . , 120h and the at least one radio access network node 140 could use the same radio access technologies (RATs). Alternatively, the at least two remote radio heads 120a, 120b, . . . , 120h use a first RAT and the at least one radio access network node 140 use a second RAT. Examples of RATs include, but are not limited to, the Global System for Mobile communications (GSM), Wideband Code Division Multiple Access (WCDMA), Long Term Evolution (LTE), Bluetooth, Wi-Fi, Worldwide Interoperability for Microwave Access (WiMAX), etc.

As an illustrative example, wireless device 150b is assumed to have an operative connection to radio access network node 140 and may thus act as an interferer to remote radio head 120g (and possibly also to remote radio head 120h). Similarly in case of Time Division Duplex (TDD) access, depending on the received signal strength level of the transmission from radio access network node 140, radio access network node 140 may act as an interferer to remote radio head 120h (and possibly also to remote radio head 120g).

In the context of the herein disclosed embodiments the at least one radio access network node 140 can thus be regarded as acting as an interferer to the radio access network 170. For TDD access the at least one radio access network node 140 can act as a direct interferer where signals transmitted by the at least one radio access network node 140 are received by at least one of the at least two remote radio heads 120a, 120b, . . . , 120h. For Frequency Division Duplex (FDD) access the at least one radio access network node 140 can act as an indirect interferer where signals transmitted by the wireless device 150b and intended to be received by the at least one radio access network node 140 are also received by at least one of the at least two remote radio heads 120a, 120b, . . . , 120h.

Further issues relating to co-existing local dedicated networks and other networks, such as macro networks, have been disclosed above. The embodiments disclosed herein relate to removing, or at least mitigating, these issues. There is provided a radio unit 200, a method performed by the radio unit 200, a computer program comprising code, for example in the form of a computer program product, that when run on a radio unit 200, causes the radio unit 200 to perform the method.

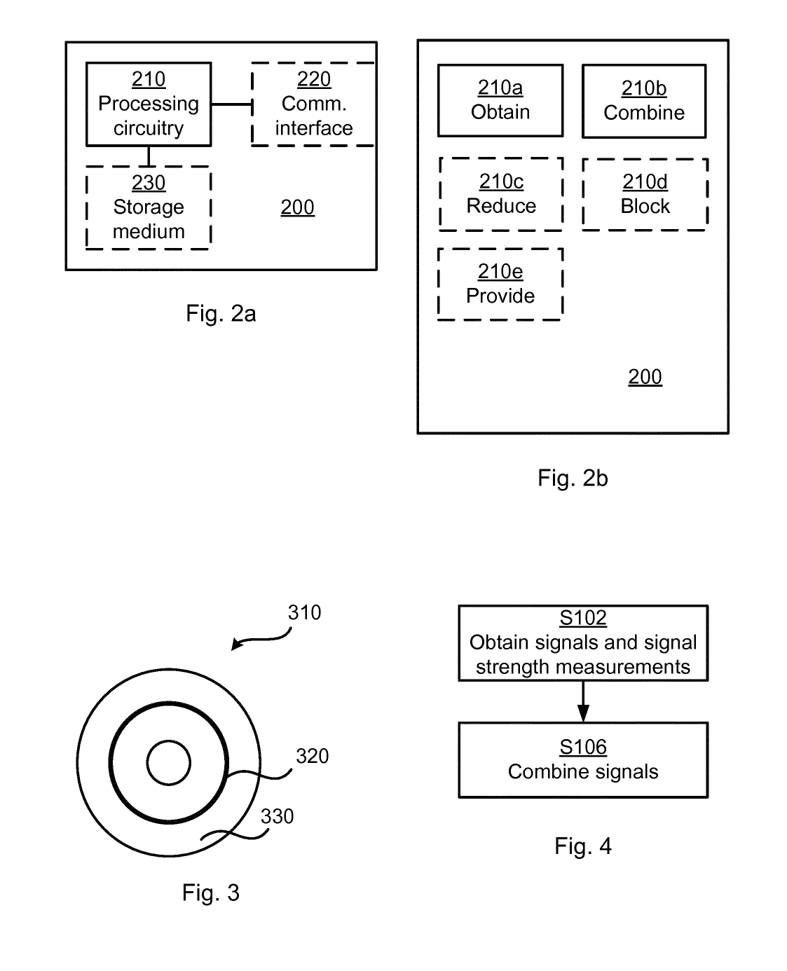

FIG. 2a schematically illustrates, in terms of a number of functional units, the components of a radio unit 200 according to an embodiment. Processing circuitry 210 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 310 (as in FIG. 3), e.g. in the form of a storage medium 230.

Particularly, the processing circuitry 210 is configured to cause the radio unit 200 to perform a set of operations, or steps, S102-S108. These operations, or steps, S102-S108 will be disclosed below. For example, the storage medium 230 may store the set of operations, and the processing circuitry 210 may be configured to retrieve the set of operations from the storage medium 230 to cause the radio unit 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The radio unit 200 may further comprise a communications interface 220 for communications with remote radio heads 120a, 120b, . . . , 120h as well as other nodes and entities, such as the radio access network node 140 and nodes and entities of the core network 160, in the communications network 100. As such the communications interface 220 may comprise one or more transmitters and receivers, comprising analogue and digital components. The processing circuitry 210 controls the general operation of the radio unit 200 e.g. by sending data and control signals to the communications interface 220 and the storage medium 230, by receiving data and reports from the communications interface 220, and by retrieving data and instructions from the storage medium 230. Other components, as well as the related functionality, of the radio unit 200 are omitted in order not to obscure the concepts presented herein.

FIG. 2b schematically illustrates, in terms of a number of functional modules, the components of a radio unit 200 according to an embodiment. The radio unit 200 of FIG. 2b comprises a number of functional modules; an obtain module 210a configured to perform below step S102, and a combine module 210b configured to perform below step S106. The radio unit 200 of FIG. 2b may further comprises a number of optional functional modules, such as any of a reduce module 210C configured to perform below step S104a, a block module 210d configured to perform below step S104b, and a provide module 210e configured to perform below steps S104c, S108. The functionality of each functional module 210a-210e will be further disclosed below in the context of which the functional modules 210a-210e may be used. In general terms, each functional module 210a-210e may in one embodiment be implemented only in hardware or and in another embodiment with the help of software, i.e., the latter embodiment having computer program instructions stored on the storage medium 230 which when run on the processing circuitry makes the radio unit 200 perform the corresponding steps mentioned above in conjunction with FIG. 2b. It should also be mentioned that even though the modules correspond to parts of a computer program, they do not need to be separate modules therein, but the way in which they are implemented in software is dependent on the programming language used. Preferably, one or more or all functional modules 210a-210e may be implemented by the processing circuitry 210, possibly in cooperation with functional units 220 and/or 230. The processing circuitry 210 may thus be configured to from the storage medium 230 fetch instructions as provided by a functional module 210a-210e and to execute these instructions, thereby performing any steps as will be disclosed hereinafter.

The radio unit 200 may be provided as a standalone device or as a part of at least one further device. For example, the radio unit 200 may be provided in a node of the radio access network or in a node of the core network. Alternatively, functionality of the radio unit 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the radio access network than instructions that are not required to be performed in real time.

Thus, a first portion of the instructions performed by the radio unit 200 may be executed in a first device, and a second portion of the of the instructions performed by the radio unit 200 may be executed in a second device; the herein disclosed embodiments are not limited to any particular number of devices on which the instructions performed by the radio unit 200 may be executed. Hence, the methods according to the herein disclosed embodiments are suitable to be performed by a radio unit 200 residing in a cloud computational environment. Therefore, although a single processing circuitry 210 is illustrated in FIG. 2a the processing circuitry 210 may be distributed among a plurality of devices, or nodes. The same applies to the functional modules 210a-210e of FIG. 2b and the computer program 320 of FIG. 3 (see below).

FIG. 3 shows one example of a computer program product 310 comprising computer readable means 330. On this computer readable means 330, a computer program 320 can be stored, which computer program 320 can cause the processing circuitry 210 and thereto operatively coupled entities and devices, such as the communications interface 220 and the storage medium 230, to execute methods according to embodiments described herein. The computer program 320 and/or computer program product 310 may thus provide means for performing any steps as herein disclosed.

In the example of FIG. 3, the computer program product 310 is illustrated as an optical disc, such as a CD (compact disc) or a DVD (digital versatile disc) or a Blu-Ray disc. The computer program product 310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 310.

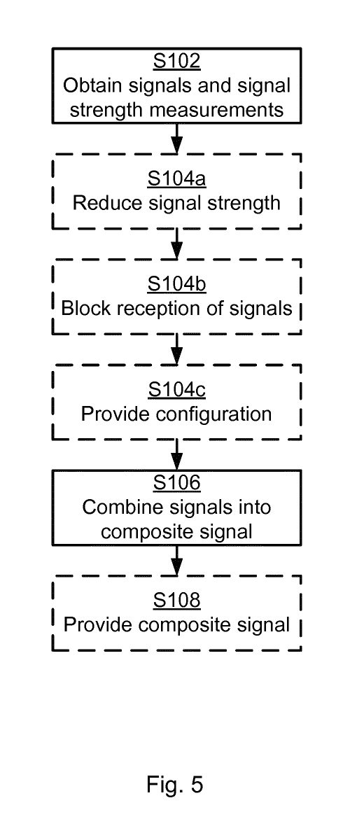

FIGS. 4 and 5 are flow chart illustrating embodiments of methods for combining signals from remote radio heads 120a, 120b, . . . , 120h in the radio unit 200. The methods are performed by the radio unit 200. The methods are advantageously provided as computer programs 320.

Reference is now made to FIG. 4 illustrating a method for combining signals from remote radio heads 120a, 120b, . . . , 120h in the radio unit 200 as performed by the radio unit 200 according to an embodiment.

The radio unit 200 is configured to, in a step S102, obtain signals and signal strength measurements thereof (i.e., of the signals) from at least two remote radio heads 120a, 120b, . . . , 120h. In this respect the obtain module 210a may comprise instructions that when executed by the radio unit 200 causes the processing circuitry, possibly in combination with the communications interface 220 and the storage medium, to obtain the signals and signal strength measurements thereof in order for the radio unit 200 to perform step S102. Embodiments of how the radio unit 200 may obtain the signals and signal strength measurements thereof from at least two remote radio heads 120a, 120b, . . . , 120h will be disclosed below.

The radio unit 200 is further configured to, in a step S106, combine the obtained signals into one composite signal. However, the radio unit 200 does not combine the obtained signals as is. It is assumed that at least one signal of the obtained signals may act as an interferer.

Signals with high signal strength measurements have the potential of blocking the radio network defined by all the remote radio heads 120a, 120b, . . . , 120h. However, such complete blocking can be avoided by considering the contribution from each individual signal and signal strength measurement thereof. The radio unit 200 therefore combines the obtained signals into one composite signal such that signals having signal strength measurements above a predefined level are muted. In this respect the combine module 210b may comprise instructions that when executed by the radio unit 200 causes the processing circuitry, possibly in combination with the communications interface 220 and the storage medium, to combine the obtained signals in order for the radio unit 200 to perform step S106. Embodiments of how the signals having signal strength measurements above the predefined level can be muted will be disclosed below.

Saturation is avoided in the radio unit 200 by muting any signals having signal strength measurements above the predefined level. This process of muting certain signals thus enable saturation of the radio network defined by all the remote radio heads 120a, 120b, . . . , 120h to be avoided and enables remote radio heads 120a, 120b, . . . , 120h not having their signals muted to stay fully operational.

The radio unit 200 may thereby create a “lock” towards the radio access network node 140 such that signalling between the radio access network node 140 and a wireless device 150b impacts the signals combined in the radio unit 200 as little as possible.

Embodiments relating to further details of combining signals from remote radio heads 120a, 120b, . . . , 120h in the radio unit 200 will now be disclosed.

Reference is now made to FIG. 5 illustrating methods for combining signals from remote radio heads 120a, 120b, . . . , 120h in the radio unit 200 as performed by the radio unit 200 according to further embodiments.

There may be different ways for the radio unit 200 to mute the signals having signal strength measurements above the predefined level. Different embodiments relating thereto will now be described in turn.

Muting can be accomplished by reducing signal levels. Particularly, according to an embodiment the radio unit 200 is configured to, in a step S104a, reduce the signal level of the signals having the signal strength measurements above the predefined level to a second predefined level. This reduction in signal level is performed prior to, or during, the combing in step S106 and causes these signals to be muted. In this respect the reduce module 210c may comprise instructions that when executed by the radio unit 200 causes the processing circuitry, possibly in combination with the communications interface 220 and the storage medium, to reduce the signal level in order for the radio unit 200 to perform step S104a.

There may be different ways to set the second predefined level. There may be situations where a complete blocking is desired. The second predefined level can therefore correspond to complete blocking of the signals. Hence the second predefined level may cause infinite reduction (blocking) of the signal. In other situations the second predefined level can be set such that the signals to be muted no longer act as interference to the other signals obtained by the radio unit 200 and that are not to be muted. Hence, the second predefined level does not necessarily correspond to complete blocking of the signals to be muted.

There may be different ways for the radio unit 200 to enable the signal level of the signals having the signal strength measurements above the predefined level to be reduced to the second predefined threshold. In general terms, the signals of the remote radio heads can either be muted during the combining in the radio unit 200 or the signal levels of these signals can be controlled by the radio unit 200.

The actual signal level reduction may be performed by the radio unit 200 itself. Hence, according to an embodiment the radio unit 200 is configured to reduce the signal strength by, in a step S104b, blocking reception of signals from the remote radio heads having signals with signal strength measurements above the predefined level. In this respect the block module 210d may comprise instructions that when executed by the radio unit 200 causes the processing circuitry, possibly in combination with the communications interface 220 and the storage medium, to block reception of signals from one or more remote radio heads 120a, 120b, . . . , 120h in order for the radio unit 200 to perform step S104b.

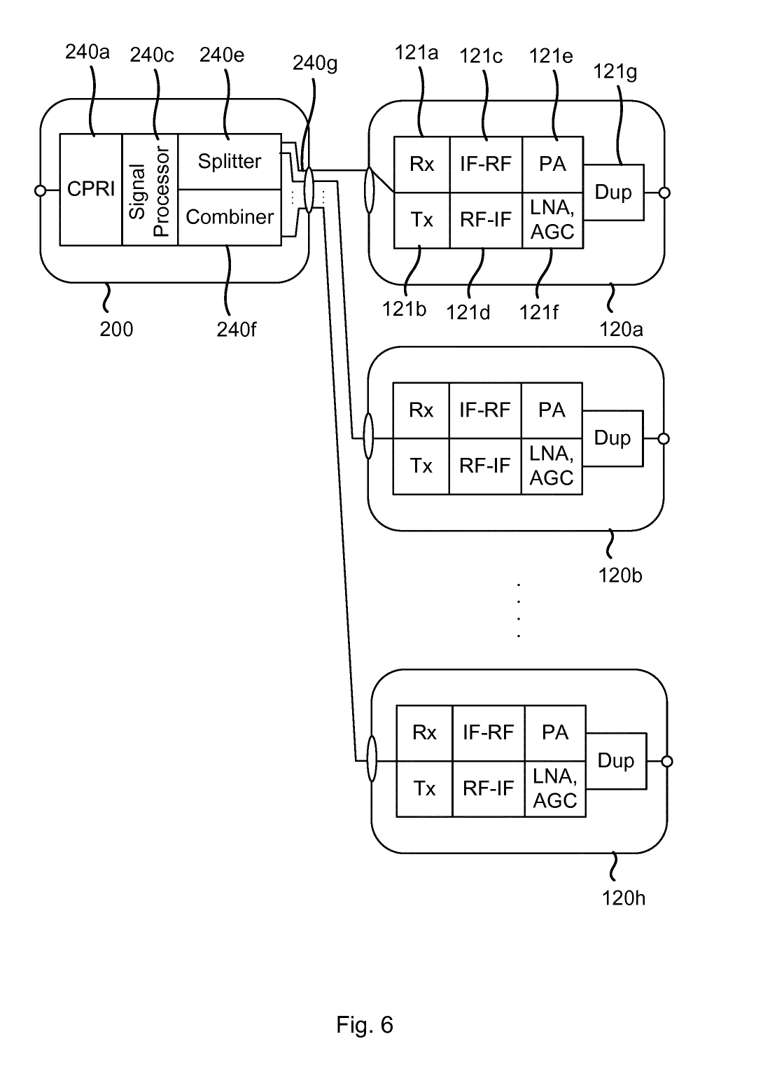

The actual signal level reduction may be performed by the remote radio heads, see further the description of FIG. 6 below. Hence, according to another embodiment the radio unit 200 is configured to reduce the signal strength by, in a step S104c, provide configuration to the remote radio heads having signals with signal strength measurements above the predefined level. In this respect the provide module 210e may comprise instructions that when executed by the radio unit 200 causes the processing circuitry, possibly in combination with the communications interface 220 and the storage medium, to provide the configuration in order for the radio unit 200 to perform step S104c. The configuration can comprise instructions for the remote radio heads to perform signal gain reduction.

There may be different causes for a signal to have a signal strength measurement above the predefined level. Different embodiments relating thereto will now be described in turn.

For example, the signal strength measurement of a signal being above the predefined level can be caused by presence of interference in that signal.

The signal strength and received signal quality (such as signal to interference and noise ratio, SINR, bit error, and/or received decoding block error) can be measured. When high signal strength and low SINR is measured at a certain remote radio head 120a, 120b, . . . , 120h this indicates a high interference in signals received from that remote radio head 120a, 120b, . . . , 120h. The received signal quality can, additionally or alternatively, be measured after combining. SINR and other quality measures as listed above may require more advanced hardware than received signal strength measurements. Then low combined received signal quality can then be used to indicate the presence of a strong interference and the high signal strength can be used to identify which remote radio head 120a, 120b, . . . , 120h that receive this interference and thus should be muted. High received signal power, and thereby potential interference, could be the result of detecting a signal strength being above the expected level, or the result of detecting that the power of a received signal is higher than what could statistically be expected. Hence, according to an embodiment the predefined level is set according to an expected signal strength level of the at least two remote radio heads 120a, 120b, . . . , 120h. The latter could e.g. be based on statistics from at least one previous communications session or by comparing received signal levels from the at least two remote radio heads 120a, 120b, . . . , 120h. Hence, according to an embodiment the predefined level is set according to a difference between the obtained signal strength measurements. Alternatively, the predefined level could be based on signal levels used for known channels, such as the random access channel (RACH), and hence, according to an embodiment, the predefined level is set according to a signal strength level of reception, such as a random access preamble, on the random access channel.

High interference can be detected by detecting unexpectedly high power levels in the remote radio heads for unscheduled resources. Hence, the predefined level can thus be set according to known scheduling. When no wireless devices 150a, 150b are scheduled by the at least two remote radio heads 120a, 120b, . . . , 120h and high signal strength is received from certain remote radio heads, such a high signal strength indicates the presence of interference. That is, according to an embodiment the signal strength measurements being above the predefined level is caused by the signals of the signal strength measurements being obtained on unscheduled radio resources. Further, as will be further disclosed below (see, FIG. 6) the radio unit 200 can comprise at least two ports, and each of the at least two remote radio heads 120a, 120b, . . . , 120h can be operatively connected to the radio unit 200 via a respective one of the at least two ports. Signal reception on the at least two ports can be switched on an off according to scheduling of the at least two remote radio heads 120a, 120b, . . . , 120h in order to cause the signal received on the ports to be individually and selectively muted.

The signal strength measurements can in step S102 be obtained per transmission time interval (TTI).

There may be different ways for the radio unit 200 to be configured to handle situations where signals are no longer required to be muted. Different embodiments relating thereto will now be disclosed in turn.

For example, according to an embodiment a remote radio head 120a, 120b, . . . , 120h from which signals are muted can be unblocked when the muted signals no longer have signal strength measurements above the predefined level. Particularly hysteresis can be applied, the signal strengths of the signals that are muted can be restored once their respective strength measurements are below a third predefined level. This third predefined level may be the same or different from the predefined level used for the muting. Also time-filtering can be applied, for example where the signal strengths of the signals that are muted are not restored until the third predefined level has been exceeded for a certain period of time.

For example, according to an embodiment, the radio unit 200 is configured to switch signal reception of signals from individual remote radio head 120a, 120b, . . . , 120h on and off in a cyclic manner. The signal reception is switched off when no communications is scheduled. Thereby, the radio unit 200 can judge which remote radio heads 120a, 120b, . . . , 120h are impacted by external interference and the interference contribution from these remote radio heads 120a, 120b, . . . , 120h can be avoided during the signal combining in step S106.

There may be different ways for the radio unit 200 to act once it has the combined the signals as in step S106. For example, the radio unit 200 may provide the composite signal to another network entity. Hence, the radio unit 200 can be configured to, in a step S108, provide the composite signal to at least one network entity, such as an entity of the core network 160. In this respect the provide module 210e may comprise instructions that when executed by the radio unit 200 causes the processing circuitry, possibly in combination with the communications interface 220 and the storage medium, to provide the composite signal in order for the radio unit 200 to perform step S108.

FIG. 6 schematically illustrates a radio unit 200 and remote radio heads 120a, 120b, . . . , 120h according to an embodiment with an analog interface for obtaining signals to the radio unit 200. The radio unit 200 comprises ports 240g. The ports 240g can be implemented by the communications interface 220 and be configured to at least partly perform step S102. The radio unit 200 comprises a signal splitter 240e. The signal splitter 240e can be implemented by the processing circuitry 210 and be configured to split signals that are to be provided to the remote radio heads 120a, 120b, . . . , 120h on the ports 240g. The radio unit 200 comprises a signal processor 240c. The signal processor 240c can be implemented by the processing circuitry 210 and be configured to perform steps S104a, S104b, S104c. The radio unit 200 comprises a signal combiner 240f. The signal combiner 240f can be implemented by the processing circuitry 210 and be configured to perform step S106. The radio unit 200 may comprise a Common Public Radio Interface (CPRI). The CPRI 240a can be implemented by the communications interface 220 and be configured to perform step S108.

As noted above (see, FIG. 1) each remote radio head 120a, 120b, . . . , 120h can be defined as a spatially separated transceiver and be connected to the radio unit 200 via a corresponding port 240g. Each remote radio head 120a, 120b, . . . , 120h comprises two radio chains; one radio chain for conversion from inter frequency (IF) to radio frequency (RF), as defined by transmitter (Tx) 121b, RF-IF converter 121d, low noise amplifier (LNA) and automatic gain controller (AGC) 121f, and one radio chain for conversion from RF to IF as defined by receiver (Rx) 121a, IF-RF converter 121C, and power amplifier (PA) 121e. The AGC 121f in each remote radio head 120a, . . . , 120h can attenuate high signal strength levels when detected. The AGC 121f can further block a received signal when it is above a certain threshold. The Rx 121a and the Tx 121b are operatively connected to one port 240g of the radio unit 200. The radio chain for conversion from IF to RF handles signals received from the radio unit 200 whilst the radio chain for conversion from RF to IF handles signals received from a wireless device 150a, 150b. Each remote radio head 120a, 120b, . . . , 120h further comprises a duplexer 121g for switching between the two radio chains.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-23. (canceled)

24. A method for combining signals from remote radio heads in a radio unit, the method comprising the radio unit:
obtaining signals and signal strength measurements thereof from at least two remote radio heads; and
combining the obtained signals into one composite signal, wherein the signals having the signal strength measurements above a predefined level are muted.

25. The method of claim 24, further comprising reducing signal level of the signals having the signal strength measurements above the predefined level to a second predefined level prior to, or during, the combing, so as to mute these signals.

26. The method of claim 25, wherein the second predefined level corresponds to complete blocking of the signals.

27. The method of claim 25, wherein the reducing comprises blocking reception of signals from the remote radio heads having signals with signal strength measurements above the predefined level.

28. The method of claim 25, wherein the reducing comprises providing configuration to the remote radio heads having signals with signal strength measurements above the predefined level.

29. The method of claim 28, wherein the configuration comprises instructions to perform signal gain reduction.

30. The method of claim 24, wherein the signal strengths of the signals that are muted are restored once their respective strength measurements are below a third predefined level.

31. The method of claim 24, wherein the signal strength measurements are obtained per transmission time interval.

32. The method of claim 24, wherein the signal strength measurements being above the predefined level is caused by the signals of the signal strength measurements being obtained on unscheduled radio resources.

33. The method of claim 24, wherein the signal strength measurements being above the predefined level is caused by presence of interference in the signals.

34. The method of claim 24, wherein the predefined level is set according to a signal strength level of a random access channel.

35. The method of claim 24, wherein the predefined level is set according to an expected signal strength level of the at least two remote radio heads.

36. The method of claim 24, wherein the predefined level is set according to a difference between the obtained signal strength measurements.

37. The method of claim 24:
wherein the radio unit comprises at least two ports; and
wherein each of the at least two remote radio heads is operatively connected to the radio unit via a respective one of the at least two ports.

38. The method of claim 37, wherein signal reception on the at least two ports is switched on an off according to scheduling of the at least two remote radio heads in order to cause the signal received on the ports to be individually and selectively muted.

39. The method of claim 24, further comprising providing the composite signal to at least one network entity.

40. A radio unit for combining signals from remote radio heads, the radio unit comprising:
processing circuitry;
memory containing instructions executable by the processing circuitry whereby the radio unit is operative to:
obtain signals and signal strength measurements thereof from at least two remote radio heads; and
combine the obtained signals into one composite signal, wherein the signals having the signal strength measurements above a predefined level are muted.

41. The radio unit of claim 40, wherein the radio unit is a radio receiver combiner, a remote radio head end, a radio control unit, or an indoor radio unit.

42. A non-transitory computer readable recording medium storing a computer program product for combining signals from remote radio heads in a radio unit, the computer program product comprising software instructions which, when run on processing circuitry of the radio unit, causes the radio unit to:
obtain signals and signal strength measurements thereof from at least two remote radio heads; and
combine the obtained signals into one composite signal, wherein the signals having the signal strength measurements above a predefined level are muted.
